(19) United States
(12) Patent Application Publication
(10) Pub. No.: US 2021/0162597 A1
(43) Pub. Date: Jun. 3, 2021

(54) MULTI AXIS ROBOT

(71) Applicant: GENESIS ROBOTICS AND MOTION TECHNOLOGIES CANADA, ULC, Langley (CA)

(72) Inventor: James KLASSEN, Surrey (CA)

(73) Assignee: GENESIS ROBOTICS AND MOTION TECHNOLOGIES CANADA, ULC, Langley, BC (CA)

(21) Appl. No.: 16/770,960

(22) PCT Filed: Dec. 6, 2018
(86) PCT No.: PCT/IB2018/059721

§ 371 Date: Jun. 9, 2020

Related U.S. Application Data
(60) Provisional application No. 62/610,185, filed on Dec. 23, 2017.
(60) Provisional application No. 62/597,203, filed on Dec. 11, 2017.

(51) Int. Cl. B25J 9/16; B25J 9/00

(52) U.S. Cl. CPC B25J 9/1651; B25J 9/1664; B25J 9/0051

(57) ABSTRACT

A method of moving a payload comprising: receiving a command to carry a payload from a first location to a second location, moving the payload along a first portion of a path between the first and second locations using a robotic arm, the first portion including the first location, moving the payload along a second portion of the path using the robotic arm, the second portion including the second location, wherein, during the movement along the first portion of the path, at least one actuator of the robotic arm is driven to exert a predetermined force to accelerate the payload and the position of the actuator is determined by a position detector to generate first position data, and wherein, during the movement along the second portion of the path, the at least one actuator of the robotic arm is driven to follow a predetermined sequence of positions.

### FIELD OF THE INVENTION

The present invention relates to a multi-axis robot, a method for operating a robot and a robotic system for carrying out the method.

### BACKGROUND OF THE INVENTION

Selective Compliance Assembly Robot Arm (SCARA) type robots are used for various tasks. However, existing SCARA robots require a significant work-space volume in order to operate.

In particular, SCARA robots are often used for “pick and place” operations, where the robot may carry a significant payload. In such operations, robots commonly exhibit high degrees of jerk, which can lead to vibrations that cause damage to the robot and may be detrimental for the payload. This problem is not unique to SCARA robots as other robots, such as Delta robots, also suffer from induced vibrations.

### SUMMARY OF THE INVENTION

A first aspect of the invention provides a method of moving a payload comprising one or more of the following steps: receiving a command to carry a payload from a first location to a second location, moving a payload along a first portion of a path between the first and second locations using a robot arm, the first portion including the first location, moving the payload along a second portion of the path using the robot arm, the second portion including the second location, wherein, during the movement along the first portion of the path, at least one actuator of the robotic arm is driven to exert a predetermined force to accelerate the payload and the position of the actuator is determined by at least one position detector to generator a first position data, and wherein, during the movement along the second portion of the path, the at least one actuator of the robot arm is driven to follow a predetermined sequence of positions, or to exert a variable force to decelerate the payload, the predetermined sequence of positions and/or the varying force being determined based at least partially on the predetermined force and the first position data.

With such a method, vibrations within the robot arm, particularly those at the start and end of a movement, can be reduced such that internal stresses in the robot arm are reduced and therefore the overall speed of the motion can be increased and the probability of damage being caused to the robot arm may be reduced.

The method may further comprise picking up the payload with the robot arm at the first location, and depositing the payload with the robot arm at the second location. This would mean that the method carries out a full “pick and place” procedure.

The payload may be held stationary before the moving at the first location and may be held stationary after the moving at the second location. This may allow more precise picking up and depositing of a payload at the first and second locations respectively. Alternatively, it may allow the payload to be used at the first and/or second location.

The variable force may be in a direction opposite to the direction of movement of the robotic arm. This may allow the payload to be decelerated at a greater rate and/or more smoothly.

The first and/or second portion of the path may extend over at least 20% of the path. With such an arrangement, the payload can be accelerated for a high portion of the movement and decelerated over a high portion of the movement, such that the movement time may be reduced and the deceleration may be more gradual, further reducing vibrations within the structure.

The predetermined force may be at least 80% of the maximum force generatable by the actuator. This may allow a further reduction in the time required for the movement.

The method may further comprise: determining the position of the actuator during the second portion of the path to produce second position data, repeating the movement of the payload, or of a further similar payload, along the path, and determining the predetermined force based at least partially on the second position data.

This may allow the robot to carry out the method multiple times and allow the robot to improve the speed of movement and reduction of vibration by using previous data within a learning algorithm.

The second position data may also be used for determining the varying force.

The payload may follow the robotic arm during the movement along the first portion of the path and the payload may lead the robotic arm during the movement along the second portion of the path. With such an arrangement, vibrations within the robotic arm may be still further reduced.

A control scheme having higher precision with regard to the position of the end effector, i.e. a position control mode, may be used momentarily at the start of a movement sequence, for example to control an initial path at the beginning of a pick and place operation. A latter part of the path may then be controlled in the force or torque mode, where position along the path is less critical. Therefore, even if the end effector is briefly initially moved in a position control mode the actuator may nevertheless generate the predetermined force to move the end effector substantially at or from the first location.

According to a second aspect of the invention, there is provided a robotic system comprising one or more of the following features: an end effector arranged to carry a payload, a first actuator arranged to generate a force to move the end effector, a control system arranged to control the first actuator, and a first position detector arranged to determine the position of the first actuator and to output first position data to the control system, wherein the control system is arranged: to receive a command to carry the payload from a first location to a second location, to drive the first actuator to move the payload along a first portion of a path between the first location and the second location using the robot arm, the first portion of the path including the first location, to drive the first actuator to move the payload along a second portion of the path using the robotic arm, the second portion of the path including the second location, the robotic system being further arranged such that, during the movement along the first portion of the path, the control system causes the first actuator to exert a predetermined force to accelerate the payload and the first position detector determines the position of the first actuator and outputs first position data to the control system, and, during the movement along the second portion of the path, the first actuator follows a predetermined sequence of positions, or exerts a varying force to decelerate the payload, the predetermined sequence of positions and/or the varying force being determined based at least partially on the predetermined force and the first position data.

With such an arrangement, there is provided a robot arm which may have a lower time for moving a payload and which may have reduced internal vibrations when moving a payload.

The robotic arm may further comprise: a second actuator arranged to generate a force to move the end effector, and a second position detector arranged to determine the position of the second actuator and to output second position data to the control system, wherein the first and second the actuators are driven with a predetermined force during movement along the first portion of the path and a different force during movement along the second portion of the path.

The first and the second actuators may be driven with forces having the same magnitude and direction during movement along the first portion of the path.

With such an arrangement, the second actuator can improve the speed of movement, while the differing drive force of the first and second actuator may avoid internal stresses being generated in the system unnecessarily.

The first and the second actuators may be elastically coupled to one another. With such an arrangement, the elastic coupling may allow energy generated by the separation of the first and second actuator to be conserved such that the overall efficiency of the robotic arm is increased.

The second actuator may be offset from the first actuator in a direction perpendicular to the path, the second actuator being nearer than the first actuator to the centre of mass of the payload, z position of the second actuator may follow a position of the first actuator during the first movement portion, and a position of the second actuator may lead a position of the first actuator during the second movement portion. With such an arrangement, the two actuators may be arranged to cooperate to improve the speed of movement of the payload, without generating internal stresses unnecessarily.

The first and second actuators may be coaxial rotation actuators, arranged to generate a torque about a shared rotational axis and the first and second actuators may be spaced apart along the shared rotational axis.

The shared rotational axis may be vertical.

The position detectors can have the form of encoders arranged within the actuators or may be formed as accelerometers or jerkmeters having computational integrators. The position detectors may be applied to the end effector or to a mechanism linking the actuators and the end effector and may therefore determine the position of a relevant actuator either directly or indirectly. Optical arrangements, such as imaging systems can also be used as position detectors.

The first and second aspects may be applied to SCARA robots, Delta robots or other robots.

According to a third aspect of the invention, there is provided a robot comprising one or more of the following features: an end effector, two coaxial first actuators having a vertical first axis, arranged to move the end effector horizontally, and two coaxial second actuators having a horizontal axis arranged to move the end effector vertically, wherein the robot is arranged to actuate each of the actuators independently to change a position and orientation of the end effector.

With such an arrangement, there is provided a robot which may have a reduced volume while providing four degrees of freedom.

The second actuators may be disposed either side of the vertical axis.

The first actuators may be coplanar. This may further reduce the volume required for the robot.

The robot may further comprise two coaxial third actuators, the third actuators being coplanar and being coaxial with the first actuators, the third actuators may lie in a plane offset from the plane of the first actuators. This may allow the robot to move the end effector with six degrees of freedom.

Each actuator may be coupled to the end effector via an arm having two rigid portions, which are hingedly connected. This may allow the robot to have a more compact arrangement.

The robot may further comprise a fourth actuator, coaxial with the first and third actuators, the fourth actuator being arranged to rotate the second actuators about the vertical axis. With such an arrangement, the robot may be able to move a payload horizontally with greater speed.

The robot may be able to rotate 360° about its base as well as translating the end effector in three dimensions as well as rotating the end effector in pitch, roll and yaw.

Various features or properties of the first aspect of the invention may be applied to the second aspect of the invention, and a method of the second aspect of the invention may be carried out by the robotic system of the first aspect of the invention.

The robotic system of the third aspect of the invention may further comprise the robotic system of the second aspect of the invention.

A fourth aspect of the invention provides a method, carried out in a computer-processor, of controlling a robot to move a payload, comprising any or all of the steps of: receiving a first command to carry a payload from a first location to a second location; in response to the first command, outputting a first signal configured to cause a first actuator to exert a predetermined force to accelerate the payload to move the payload along a first portion of a path between the first location and the second location, the first portion of the path including the first location, receiving first position data, the first position data containing information about the position of the first actuator during movement along the first portion of the path, determining a predetermined sequence of positions, or a varying force to decelerate the payload, based at least partially on the first position data, outputting a second signal configured to cause the first actuator to follow the predetermined sequence of positions, or to exert the varying force, to move the payload along a second portion of the path, the second portion of the path including the second location.

The method of the fourth aspect may be used in the robotic system of the second or third aspect and may carry out any of the further methods or method steps detailed according to the first aspect.

A fifth aspect of the invention provides an apparatus, comprising:

at least one processor; and

at least one memory including computer program code;

the at least one memory and the computer program code configured to, with the at least one processor, cause the apparatus to perform any of the methods described herein.

The apparatus may further comprise at least one output port; and preferably at least one input port. The first position data is preferably received at the input port. The first and/or second signals are preferably output from the at least one output port.

A sixth aspect of the invention provides a computer program, comprising code for carrying out each of the steps of any of the methods described herein.

A seventh aspect of the invention provides a non-transitory computer-readable medium including instructions which, when executed by a processor, cause the processor to carry out any of the methods described herein.

### BRIEF DESCRIPTION OF THE DRAWINGS

Embodiments of the invention will now be described with reference made by way of example only to the accompanying drawings, in which:

FIG. 1 shows a robot according to an embodiment of the invention;

FIG. 2 shows a robot according to a further embodiment of the invention;

FIGS. 3a, 3b, 3c, 3d and 3e show schematic diagrams of portions of movement of a payload according to the present invention;

FIG. 4 shows a schematic drawing of a control system for use in a robot according to the invention; and

FIG. 5 shows a flowchart representing a method according to the invention.

### DETAILED DESCRIPTION OF EMBODIMENTS

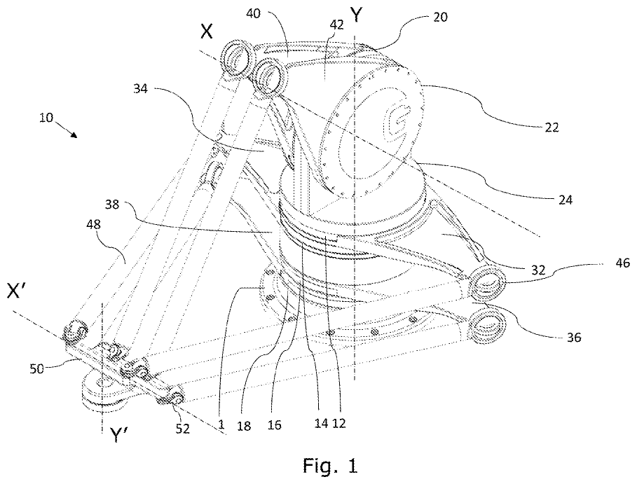

FIG. 1 shows a robot according to an embodiment of the invention.

The robot 10 has two first actuators 12, 14, which are rotatable about vertical axis Y. The robot has two second actuators 20, 22, which are rotatable about a horizontal axis X. The robot 10 also has two third actuators 16, 18, which are rotatable about the vertical axis Y. The two third actuators may be offset from the first actuators 12, 14 in a direction along the vertical axis Y. Each of the actuators 12, 14, 16, 18 are fixed to the base 1 via a central anchoring pillar (not shown) which extends through the centre of the robot 10. The second actuators 20, 22 are each anchored to a vertical support extending between the second actuators, 20, 22.

The robot also comprises a seventh actuator 24, which is anchored to the base 1 via the central anchoring portion extending through the robot 10, The seventh actuator 24 is arranged to rotate the second actuators, 20, 22 about the vertical axis Y. This can reduce the load on the first and third actuators 12, 14, 16, 18 and may also increase the speed of rotation of the robot 10 when the robot 10 is moving a payload.

The robot 10 has an end effector 50. While the end effector 50 is shown only with a screw hole in FIG. 1, the skilled person will understand that the end effector 50 could be arranged with a claw or hand for carrying a payload or may have any other tool associated with it.

The actuators are coupled to the end effector 50 via arms and rods. Each first actuator 12, 14 is coupled to a first arm 32, 34; each second actuator 20, 22 is coupled to a second arm 40, 42; and each third actuator 16, 18 is coupled to a third arm 36, 38. The arms are directly, rigidly coupled to the actuators such that they rotate about the axis X, Y with their respective actuators.

Each arm is coupled to the end effector 50 via a rod 48 and a ball joint 56, forming a series of four-bar linkages. In particular, the first actuators 12, 14 form part of a planar four-bar linkage with the end effector 50 and the third actuators 16, 18 form part of a planar four-bar linkage with the end effector 50.

The rods 48 are each coupled to the end effector 52 via a universal joint 52.

While ball joints 46 and universal joints 52 are shown linking the arms and rods and the arms and end effector respectively, it will be understood by a skilled person that alternative joining means may be used, such as hinge joints.

As can be seen in FIG. 1, the first actuators 12, 14 and the first arms 32, 34 are substantially coplanar. This has the effect that their relative movement causes substantially no rotation of the end effector 50 about a horizontal axis. The third actuators 16, 18 and third arms 36, 38 are also substantially coplanar and are spaced apart along vertical axis Y from the first actuators 12, 14 and the first arms 32, 34. By spacing apart the first actuators 12, 14 and third actuator 16, 18, the relative movement between the first actuators 12, 14 and the third actuators 16, 18 can move the end effector 50 such that it rotates about a horizontal axis X′.

The second actuators 20, 22 are spaced apart along the horizontal axis X such that the rods which couple the arms 40, 42 to the end effector 50 are spaced apart horizontally. This has the effect that relative movement between the second actuators 20, 22 can cause the end effector 50 to rotate about a vertical axis Y′ extending through the end effector 50.

Overall, therefore, the robot 10 can move the end effector 50 in six degrees of freedom.

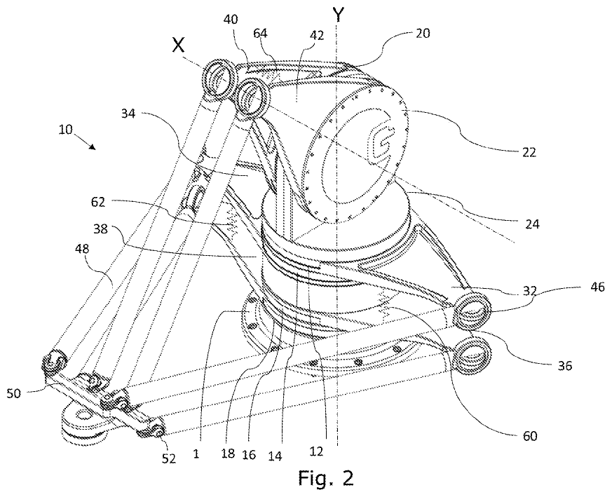

FIG. 2 shows a robot arrangement substantially similar to that of FIG. 1, with three elastic members 60, 62, 64. The first elastic member 60 is coupled between the first and third actuators 36, 32; the second elastic member 62 is coupled between the first and third actuators 34, 38 and the third elastic member 64 is coupled between the second actuators 40, 42. By coupling the actuator arms via elastic members, relative movement between certain pairs of actuators can generate elastic potential energy, which may be recovered as the actuators move toward a position in which they are in alignment with one another, in order to coincide with each other.

The elastic members 60, 62, 64 may be arranged such that a minimal restoring force is generated by the elastic members when the actuator arms to which they are connected are aligned so as to minimise the length of the elastic members.

The elastic members may be leaf springs arranged to provide restoring forces only parallel to the direction of motion of the respective actuator arms to which they are attached.

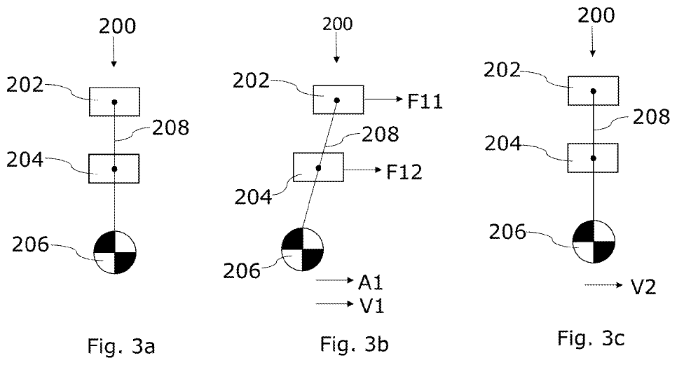

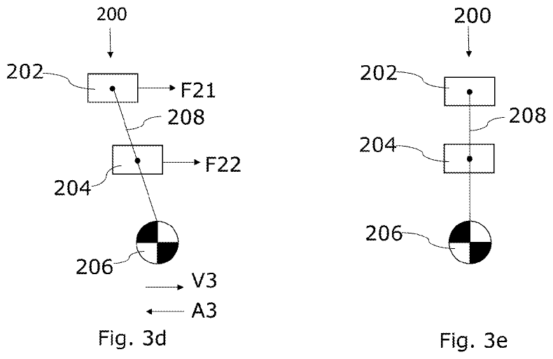

This energy conserving aspect of the embodiment shown in FIG. 2 may further increase efficiency when coupled with the active compliance scheme demonstrated with reference to FIGS. 3a to 3e.

FIGS. 3a to 3e show various stages of movement of a payload 206 by a robotic system 200 according to the present invention.

The FIGS. 3a to 3e are shown in a chronological order as the payload 206 moves from a first location at FIG. 3a to a second location at FIG. 3e.

At FIG. 3a, the payload 206 is held stationary at a first location and is held by an end effector 208, which is connected to a first actuator 202 and a second actuator 204, the first actuator 202 being situated further from the centre of mass of the payload 206 than the second actuator 204 is situated from the centre of mass of the payload 206.

In FIG. 3b the payload 206 is being accelerated in a rightward direction, as indicated by arrow A1, such that the payload is moving with a velocity V1 in a rightward direction, as indicated by the arrow V1. The movement is generally from a first location to a second location. The velocity of the payload may be increasing during this first portion of the movement. The first actuator 202 and second actuator 204 may be generating forces towards the right, as indicated by respective arrows F11 and F12. The forces generated by the first actuator 202 and the second actuator 204 may have the same direction and magnitude and may have the result that the first actuator 202 moves a further distance than the second actuator 204 because the first actuator 202 is situated a greater vertical distance from the payload 206 than the second actuator 204 is situated. The end effector 208 may therefore rotate about a horizontal axis.

While the payload 206 is being accelerated during this first portion of movement, the position of the first and/or second actuators 304, 308 may be determined by one or more position sensors, which may provide position data to a control unit. However, the driving force of the first and/or second actuators 304, 308 during the first stage of movement can be constant and might not be changed based on the position data.

The manner of movement of the first portion of movement may be described as a “torque mode” or “force mode”, where the actuators 202, 204 are operated according to a required force as opposed to a required position.

The stage of movement shown at FIG. 3c is an intermediate, transitionary stage of movement, in which the payload 206 may or may not be accelerating, but will be moving towards the right as indicated by arrow V2. The first and second actuators 202, 204 may be vertically realigned and may be exerting differing forces on the end effector 208.

During this intermediate portion of movement, the payload may move between a first position, in the first portion of a path between first and second locations, where the payload 206 lags or follows the first and second actuators 202, 204 to a position in a second portion of the path between the first and second locations, where the payload 206 leads the first and second actuators 202, 204. The first and second actuators 202 and 204 can exert varying forces in order to move the payload 206 in between these positions.

It is also possible that, during at an intermediate portion of the movement, the forces generated by the first and second actuators 202, 204 may equal the resistive forces of friction and air resistance being applied to the end effector 208 and payload 206, leading to an equilibrium state, which may result in a substantially constant speed for at least some of the path from the first position to the second position.

A control unit can determine what specific forces the actuators 202, 204 should generate to return the end effector 208 to a specific attitude in the intermediate step, for example at a mid-point of a path between a first and a second location. The “correct” attitude may be a vertical attitude.

The midpoint may represent a transition point between first and second portions of the movement, after which the system may operate in a “position mode”.

The “midpoint of the motion” may be within a small distance of the midpoint of the desired trajectory. When the end effector reaches the midpoint of the motion, the control unit may switch mode of control into a mode whereby a new desired trajectory of the end-effector for the remainder of the path is created, the new desired path being symmetric to the actual motion from the first part of the path, in all six degrees of freedom. The new desired path may be taken to mean a prescribed trajectory as a function of time. The generated forces may be varied so as to minimize the deviations of the robot end effector from the new desired path.

In FIG. 3d, a stage of movement is shown where the payload 206 is decelerating, as shown by arrow A3, while the payload still moves rightward as shown by arrow V3. While the payload 206 is decelerating, the first actuator 202 and second actuator 204 may generate differing forces, indicated respectively by arrows F21 and F22. While both arrows F21 and F22 are directed rightwardly, the arrows could equally be drawn towards the left hand direction to show that the forces generated by the first actuator 202 and the second actuator 206 may be in a direction opposite to the direction of the velocity of the payload. It is also envisioned that the force F21 and the force F22 may be in opposite directions.

The actuators 202, 204 may generate forces in a rightward direction, i.e. in the direction of movement of the payload of a magnitude smaller than resistive forces such as friction and air resistance acting on the end effector 208 and payload 206. This may lead to a controlled deceleration of the payload 206.

The manner of operating the actuators 202, 204 during the second portion of movement may be characterised by defining that particular positions are assumed by the first and/or second actuators 202, 204 and/or the payload 206 at particular times. Such a manner of operation may be referred to as a “position mode” of control.

In FIG. 3e, the payload 206 is shown stationary at a second location.

It is also envisioned that the movement could equally be performed having only a single actuator, as opposed to two actuators.

Each of the first and second actuators 202, 204 may be formed by two or more actuators working together, for example using the SCARA robot shown in FIGS. 1 and 2.

The method can analogously be applied to a system having 3 or more actuators operating to move an end effector and/or a payload.

The payload does not necessarily have to be an item carried by an end effector. Where the end effector is a tool, for example a drill or electric screwdriver, the end effector may have a significant weight itself and the above method can be applied to move an end effector, with the centre of mass of the end effector replacing the centre of mass of the payload in the above example.

The overall shape of the movement path may be determined by reversing the shape and speed and attitude of the end effector 208 during the first portion of the movement in the second portion of the movement. This can provide a precise position control during deceleration of the payload 206 in a second portion of the movement.

While the movement shown in FIGS. 3a-3e has only a single degree of freedom and is a substantially linear system, in view of the general teaching herein and the number of degrees of freedom present in the illustrated robots it will be apparent that the method may be carried out in systems having more degrees of freedom, including 6 degrees of freedom. The paths and positions defined and processed herein may therefore be 3 dimensional and in any suitable number of degrees of freedom of a robot.

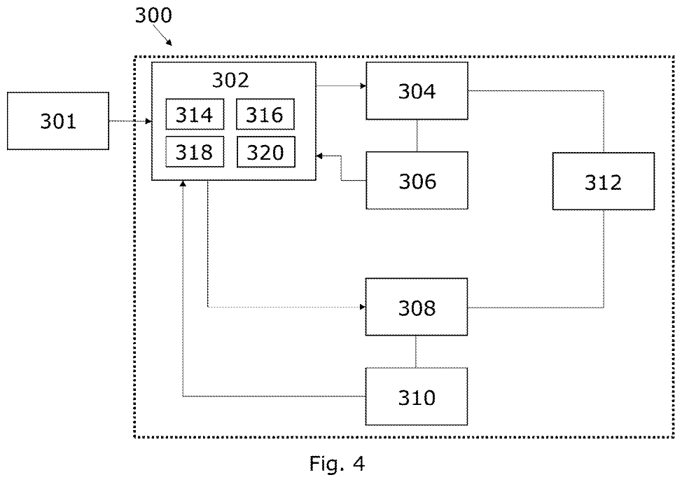

FIG. 4 shows a robotic system 300 arranged to carry out a movement as shown in FIGS. 3a to 3e. The robotic system 300 comprises a control unit 302, which may comprise a processor and a memory, optionally a non-transitory memory.

The control unit 302 may receive a command from a user 301. The command may specify that an end effector and/or a payload is to be moved from a first location to a second location and, optionally, may specify one or more aspects or points of the path by which the movement is to take place. The user 301 may be a human user or may be a separate computing system.

The control unit 302 can drive a first actuator 304 via an electronic signal and a first position sensor 306 can determine the position of the first actuator 304 and the first position sensor 306 can transfer position data to the control unit 302. The first actuator 304 can be coupled to an end effector 312 such that the first actuator can move the end effector 312. The coupling between the first actuator 304 and the end effector 312 may be either direct coupling or via a mechanism, such as a four-bar linkage.

The control unit 302 can also move a second actuator 308 and a second position sensor 310 can determine the position of the second actuator 308 and the second position sensor 310 can then transfer second position data to the control unit 302. Similar to the first actuator 304, the second actuator 308 can move the end effector 312 via a mechanism or directly.

The position sensors 306, 310, also referred to as position detectors, can be provided in the form of encoders arranged within the first and/or second actuators 304, 308 or may be formed as accelerometers or jerkmeters having computational integrators. The position sensors 306, 310 may be applied to the end effector 312 or to a mechanism linking the actuators and the end effector.

The control unit 302 can store the first and second position data in a memory 314 which may be a non-transitory memory and can use the first and/or second position data in order to determine with what force to drive the first and second actuators 304, 308.

The control unit 302 may also have a processor 316 arranged to carry out instructions stored on the memory 314. The control unit 302 may have one or more input ports 318 and one or more output ports 320 arranged to connect to relevant sensors or actuators for operating a robotic system.

The control unit 302 can store the position data and the output torque together in order to run a learning algorithm so that further iterations of the method may be run more smoothly, i.e. with reduced vibrations and/or with faster movement.

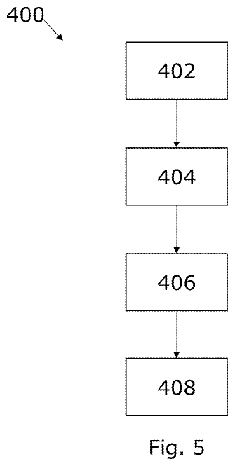

FIG. 5 shows a flowchart representing a processor-implemented method 400 for moving a payload according to the present invention.

At step 402 of the method, a first command is provided to a control unit. The command may be to move a payload from a first location to a second location and may optionally specify one or more points on a predetermined path for the movement through which the payload or a related end effector should pass. The first and second locations may be specified as a set of coordinates, such as Cartesian or polar coordinates. The first and/or second locations may be defined with a certain tolerance, or as a point, or by a shape in space from which the payload should be taken and into which it should be deposited at the second location. For example, the first and/or second locations may be defined as a 2D square or other shape or polygon defined in a plane, such as on a surface. The first and/or second locations may alternatively be defined as a 3D volume in space such as a sphere, cube or other 3D polygonal volume, or as another shape, centred around a reference point defined by suitable coordinates. The first command may further specify one or more intermediate locations between the first and second locations, through which the payload or an end effector carrying the payload should travel.

At step 404, the control unit can output a signal to cause an actuator of a robot to move a payload along a first portion of a path from the first location to the second location with a predetermined force. The predetermined force may be based upon a predetermined maximum output of an actuator of the robot. The predetermined force may be developed by a number of actuators acting together, such as two actuators acting in a same direction or about a common axis, or by two or more actuators acting about different axes, which different axes may be co-axial or not coaxial, or which may be parallel or non-parallel. In general terms, the predetermined force is applied to the payload from one or more actuators. The predetermined force may be applied without any control of the position of the payload or its related end effector. As such, the position of the payload at each point in time is defined by the balance of static and dynamic forces on the payload. No position control feedback may be used in this stage. This type of control may be considered a ‘force mode’ type of control, or a ‘torque-mode’ type of control in the case of rotational actuators. During step 404, no position control feedback is therefore necessary and the actuator can operate in an open-loop manner. However, as set out below, a sequence of positions of the payload and/or its related end effector and/or one or more actuators configured for moving the end effector, may be recorded in a memory.

During step 404, the control unit may receive first position data from a first position sensor, which may detect a position of the actuator(s) and/or the payload during the movement along the first portion of the path. The position data may be received and/or recorded in the form of a series of coordinates of any suitable kind, or recorded as a mathematical approximation to the path of the payload or end effector. The position data may be recorded as direct position data relating to a position or positions of one or more actuators which are actuated to move the payload along the path between the specified locations. The path of the payload or end effector may not be recorded directly, but may be calculable from the recorded positions of the actuator or actuators actuated to move the payload or end effector. By any such suitable means, the position data is recorded in such as way a recorded path or sequence of positions of the payload or end effector can be reproduced from the recorded first position data.

At step 406, the control unit may process the first position data in order to determine the movement of any or all of the payload, the end effector, and one or more actuators actuated to move the payload or end effector, which is to be performed along a second portion of the path between the first location and the second location. The second portion may comprise the second location, and may represent a sub-section of the path from the first location to the second location. Using the first position data as an input, the processor may determine control data for the second portion of the path from the first location to the second location. The control data may be processed by the controller to represent a reversal of the sequence of positions recorded during the first portion of the path. In this manner at least one aspect of the sequence of positons of the first position data may be reversed, to produce a target set of positions for the second portion of the path. The first position data may therefore be substantially mirrored about a point in the path from the first location to the second location.

The processing at step 406 may be to calculate a series of points, and, optionally, corresponding timings, for the second portion of the path. This may form a substantial mirror image in 3D space of the first portion of the path, with a mirrored velocity profile and/or a mirrored speed, force and/or orientation profile. This can enable the dynamics of the system during the force-mode or torque-mode acceleration of the payload away from the first location to be used to determine a predetermined output signal to drive the actuators of the system as the payload is decelerated toward the second location.

The series of points may be points in any coordinate system, in particular polar or cylindrical coordinates, which may be particularly beneficial if rotational actuators are used, spherical coordinates, which may be particularly beneficial if gimbals are used, or three-dimensional Cartesian coordinates, which may be particularly beneficial if linear actuators are used.

The processing may alternatively determine a mass and/or moment of inertia of the payload, based on the first position location and the predetermined force input to the system. This may be done by inputting the force input and the first position data into a suitable equation or control logic to calculate one or more of those properties. The controller may then use data in an equation or suitable processing logic in order to determine a varying torque for moving the payload along a second portion of the path and, optionally, bringing the payload to rest at the second location.

At step 408 the payload may be moved over the second portion of the path, to the second location. This moving step may involve a feedback loop in order to move the payload to a series of points determined at step 406 or may use a predetermined variable force determined at step 406.

During step 408, second position data may be obtained and stored in order to be used when similar payloads are moved in future, to improve the speed and/or smoothness of the movement as part of a learning algorithm.

In a further example, there is provided a control strategy whereby a desired end effector path is prescribed and the control strategy has the following phases:

a. A first phase wherein the joint torques are controlled to follow torque values that were estimated, a priori, or generally estimated in advance, to produce the correct motion to travel to the midpoint of the path.

b. A second phase which is activated prior to reaching the midpoint of the desired end effector path, and wherein the joints torques are adjusted to correct for deviations from the desired end effector path.

c. A third phase which is activated when the midpoint of the desired end effector path is reached, and wherein the joint torques are continuously adjusted to cause the end effector to travel along a second path, where the second path begins at the midpoint of the desired end effector path, ends at the end of the desired end effector path, and is symmetric to the actual trajectory of the end effector from the beginning of the path to the midpoint of the path.

Although the invention has been described above with reference to one or more preferred embodiments, it will be appreciated that various changes or modifications may be made without departing from the scope of the invention as defined in the appended claims.

1. A method of moving a payload comprising:
receiving a command to carry a payload from a first location to a second location,
moving the payload along a first portion of a path between the first and second locations using a robotic arm, the first portion including the first location,
moving the payload along a second portion of the path using the robotic arm, the second portion including the second location,
wherein, during the movement along the first portion of the path, at least one actuator of the robotic arm is driven to exert a predetermined force to accelerate the payload and the position of the actuator is determined by a position detector to generate first position data, and
wherein, during the movement along the second portion of the path, the at least one actuator of the robotic arm is driven to follow a predetermined sequence of positions, or to exert a variable force to decelerate the payload, the predetermined sequence of positions and/or the variable force being determined based at least partially on the first position data.

2. The method of claim 1, wherein the method further comprises:
picking up the payload with the robot arm at the first location, and
depositing the payload with the robot arm at the second location.

3. The method of claim 1, wherein the payload is held stationary before the moving at the first location and is held stationary after the moving at the second location.

4. The method of claim 1, wherein the variable force is in a direction opposite to the direction of movement of the robotic arm.

5. The method of claim 1, wherein the first and/or second portion of the path extends over at least 20% of the path.

6. The method of claim 1, wherein the predetermined force is at least 80% of the maximum force generatable by the actuator.

7. The method of claim 1, further comprising:
determining the position of the actuator during the second portion of the path to produce second position data,
repeating the moving of the payload, or of a further similar payload, along the path, and
determining the predetermined force based at least partially on the second position data.

8. The method of claim 1, wherein the payload follows the robotic arm during the movement along the first portion of the path and the payload leads the robotic arm during the movement along the second portion of the path.

9. A robotic system, comprising:
an end effector arranged to carry a payload,
a first actuator arranged to generate a force to move the end effector,
a control system arranged to control the first actuator, and
a first position detector arranged to determine the position of the first actuator and to output first position data to the control system,
wherein the control system is arranged:
to receive a command to carry the payload from a first location to a second location,
to drive the first actuator to move the payload along a first portion of a path between the first location and the second location using the end effector, the first portion of the path including the first location,
to drive the first actuator to move the payload along a second portion of the path using the end effector, the second portion of the path including the second location,
the robotic system being further arranged such that:
during the movement along the first portion of the path, the control system causes the first actuator to exert a predetermined force to accelerate the payload and the first position detector determines the position of the first actuator and outputs first position data to the control system, and
during the movement along the second portion of the path, the first actuator follows a predetermined sequence of positions, or exerts a varying force to decelerate the payload, the predetermined sequence of positions and/or the varying force being determined based at least partially on the predetermined force and the first position data.

10. The robotic system of claim 9, further comprising:
a second actuator arranged to generate a force to move the end effector, and
a second position detector arranged to determine the position of the second actuator and to output second position data to the control system,
wherein the first and the second actuators are driven with a same predetermined force during movement along the first portion of the path and driven with a different force during movement along the second portion of the path.

11. The robotic system of claim 10, wherein the first and the second actuators are elastically coupled to one another.

12. The robotic system of claim 10, wherein the second actuator is offset from the first actuator in a direction perpendicular to the path, the second actuator being nearer than the first actuator to the centre of mass of the payload, and
wherein a position of the second actuator follows the first actuator during the first portion of the path, and
wherein a position of the second actuator leads the position of the first actuator during the second portion of the path.

13. The robotic system of claim 10, wherein the first and second actuators are coaxial rotational actuators, arranged to generate a torque about a shared rotational axis and the first and second actuators are spaced apart along the shared rotational axis.

14. The robotic system of claim 13, wherein the shared rotational axis is vertical.

15-20. (canceled)

21. The robotic system of claim 9, wherein the system is arranged to carry out a method of moving a payload comprising:
receiving a command to carry a payload from a first location to a second location,
moving the payload along a first portion of a path between the first and second locations using a robotic arm, the first portion including the first location,
moving the payload along a second portion of the path using the robotic arm, the second portion including the second location,
wherein, during the movement along the first portion of the path, at least one actuator of the robotic arm is driven to exert a predetermined force to accelerate the payload and the position of the actuator is determined by a position detector to generate first position data, and
wherein, during the movement along the second portion of the path, the at least one actuator of the robotic arm is driven to follow a predetermined sequence of positions, or to exert a variable force to decelerate the payload, the predetermined sequence of positions and/or the variable force being determined based at least partially on the first position data.

22. The robotic system of claim 9, further comprising a robot, the robot comprising:
an end effector,
two coaxial first actuators having a first axis, arranged to move the end effector in a direction perpendicular to the first axis, and
two coaxial second actuators having a second axis, the second axis being at a non-zero angle to the first axis, the second actuators being arranged to move the end effector in a direction perpendicular to the second axis,
wherein the robot is arranged to actuate each of the actuators independently to change a position and orientation of the end effector.

23-27. (canceled)
